(19) United States
(12) Patent Application Publication
(10) Pub. No.: US 2024/0342906 A1
(43) Pub. Date: Oct. 17, 2024

(54) INFORMATION PROCESSING APPARATUS, INFORMATION PROCESSING METHOD, AND ROBOT CONTROL SYSTEM

(71) Applicant: SONY GROUP CORPORATION, TOKYO (JP)

(72) Inventor: HIROTAKA SUZUKI, TOKYO (JP)

(21) Appl. No.: 18/700,073

(22) PCT Filed: Sep. 9, 2022
(86) PCT No.: PCT/JP2022/033865

§ 371 Date: Apr. 10, 2024

(30) Foreign Application Priority Data
Oct. 18, 2021 (JP) 2021-170152

(51) Int. Cl. B25J 9/16; B25J 13/08

(52) U.S. Cl. CPC B25J 9/1653; B25J 9/1664; B25J 13/084

(57) ABSTRACT

An information processing apparatus according to an embodiment of the present technology includes a stiffness control unit. The stiffness control unit controls, on the basis of a detection result of a pressure sensor provided at a position using a joint of a robot arm as a reference, stiffness regarding driving of the joint of the robot arm. In this information processing apparatus, for example, an operator is able to simultaneously set stiffness while inputting motion, and therefore the operator's labor associated with the input of the motion and the setting of the stiffness is reduced. Accordingly, the robot arm can be accurately driven.

### TECHNICAL FIELD

The present technology relates to an information processing apparatus, an information processing method, and a robot control system that are capable of controlling driving of a robot arm.

### BACKGROUND ART

Patent Literature 1 has disclosed a tactile sensor attached to a link portion of a robot arm. The tactile sensor is formed of a soft material in a sheet shape. Accordingly, the tactile sensor can be easily attached by being wrapped around the link portion. Moreover, the tactile sensor does not need to be attached to a joint of the robot arm, and therefore it does not interfere with the operation of the robot arm.

### CITATION LIST

### Patent Literature

Patent Literature 1: Japanese Patent Application Laid-open No. 2003-071778

### DISCLOSURE OF INVENTION

### Technical Problem

It is important to accurately operate such a robot arm during the use.

In view of the above-mentioned circumstances, it is an objective of the present technology to provide an information processing apparatus, an information processing method, and a robot control system that are capable of accurately operating the robot arm.

### Solution to Problem

In order to accomplish the above-mentioned objective, an information processing apparatus according to an embodiment of the present technology includes a stiffness control unit.

The stiffness control unit controls, on the basis of a detection result of a pressure sensor provided at a position using a joint of a robot arm as a reference, stiffness regarding driving of the joint of the robot arm.

In this information processing apparatus, the stiffness regarding driving of the joint of the robot arm is controlled on the basis of the detection result of the pressure sensor. Accordingly, the robot arm can be accurately driven.

The information processing apparatus may further include a storage unit that stores the stiffness set by the stiffness control unit and motion of the robot arm by driving of the joint in association with each other.

The storage unit may store the stiffness and the motion in association with each other in a case where a direct teaching mode on which an operator moves the robot arm and stores a predetermined motion is selected.

The robot arm may include one or more joints and one or more links, the one or more links rotating or translating by driving of each of the one or more joints. In this case, the stiffness control unit may control stiffness regarding rotation or translation of the one or more links.

The information processing apparatus may further include a storage unit that stores the stiffness set by the stiffness control unit and a track of the link by driving of the joint in association with each other.

The storage unit may store the stiffness and the track in association with each other in a case where a direct teaching mode on which an operator moves the link and stores a predetermined track is selected.

The stiffness control unit may control the stiffness to increase along with an increase in pressure detected by the pressure sensor.

The pressure sensor may be provided in a region that is a hold target of the link when an operator moves the link.

The information processing apparatus may further include a notification control unit that controls notification of the stiffness set by the stiffness control unit.

The notification control unit may control at least one of display of a value of the stiffness, display of a gauge according to a level of the stiffness, display of a color according to a level of the stiffness, or audio output of the stiffness.

The notification control unit may set, in accordance with the stiffness set by the stiffness control unit, stiffness for teaching when an operator moves the link and performs teaching.

The notification control unit may set the stiffness for the teaching to increase along with an increase in the stiffness set by the stiffness control unit.

The stiffness control unit may retain a maximum value of pressure detected by the pressure sensor and set the stiffness according to the retained maximum value.

The stiffness control unit may decrease the stiffness in a case where a predetermined manipulation is input to the pressure sensor.

The predetermined manipulation may include a stroke manipulation.

The pressure sensor may be a tactile sensor.

An information processing method according to an embodiment of the present technology is an information processing method executed by a computer system and includes controlling, on the basis of a detection result of a pressure sensor provided at a position using a joint of a robot arm as a reference, stiffness regarding driving of the joint of the robot arm.

A robot control system according to an embodiment of the present technology includes the robot arm, the pressure sensor, and the stiffness control unit.

### BRIEF DESCRIPTION OF DRAWINGS

FIG. 1 A schematic view mainly showing hardware configuration examples of a robot control system.

FIG. 2 A schematic view mainly showing functional configuration examples of the robot control system.

FIG. 3 A flowchart showing basic processing examples on a direct teaching mode.

FIG. 4 A schematic view showing an example of motion of a robot arm stored by direct teaching.

FIG. 5 A flowchart showing a processing example on the direct teaching mode.

FIG. 6 A schematic view showing an example of averaging processing for pressure distribution data.

FIG. 7 A schematic view showing an example of notification control on stiffness by a notification control unit.

FIG. 8 A schematic view mainly showing functional configuration examples of the robot control system.

FIG. 9 A flowchart showing a processing example on the direct teaching mode.

FIG. 10 A schematic view showing an example of determination processing by a stroke determination unit.

FIG. 11 A block diagram showing hardware configuration examples of a computer capable of realizing an information processing apparatus.

### MODE(S) FOR CARRYING OUT THE INVENTION

Hereinafter, embodiments according to the present technology will be described with reference to the drawings.

### First Embodiment

A first embodiment of a robot control system according to the present technology will be described.

### [Configuration of Robot Control System]

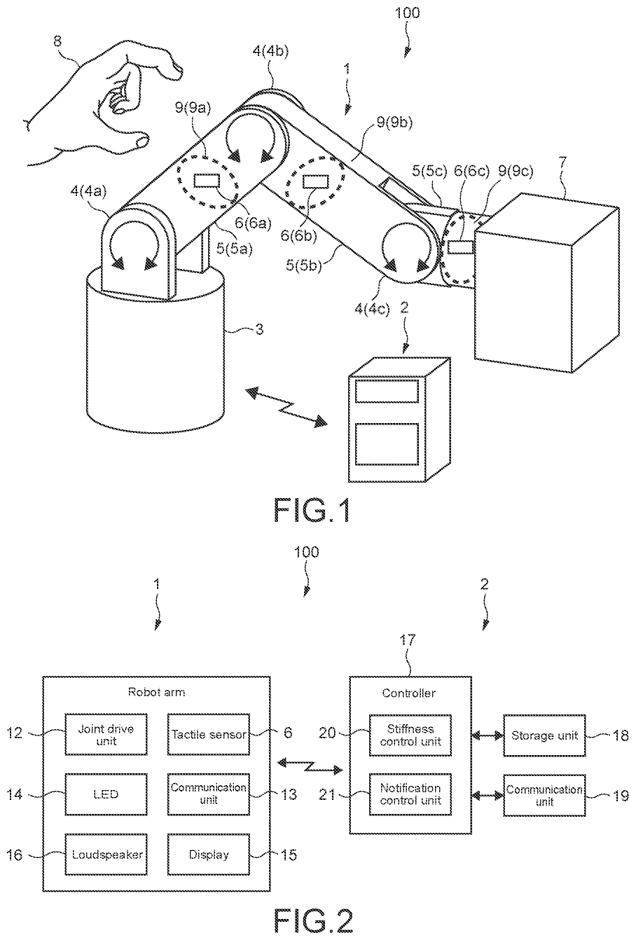

FIGS. 1 and 2 are schematic views showing configuration examples of the robot control system.

FIG. 1 mainly shows hardware configuration examples of the robot control system.

FIG. 2 mainly shows functional configuration examples of the robot control system.

As shown in FIG. 1, a robot control system 100 includes a robot arm 1 and an information processing apparatus 2. In the present embodiment, the single robot arm 1 and the single information processing apparatus 2 constitute the robot control system 100. The present technology is not limited thereto, and a plurality of robot arms 1 or a plurality of information processing apparatuses 2 may constitute the robot control system 100.

The robot arm 1 and the information processing apparatus 2 are connected to be capable of communicating with each other with a wire or wirelessly. The connection form between the respective devices is not limited. For example, wireless LAN communication such as WiFi or near-field communication such as Bluetooth (registered trademark) can be used therefor.

The robot arm 1 has a proximal portion 3, a plurality of joints 4 (4a to 4c), a plurality of links 5 (5a to 5c), a plurality of tactile sensors 6 (6a to 6c), and an end effector 7.

The proximal portion 3 supports the entire robot arm 1. As shown in FIG. 1, in the present embodiment, the proximal portion 3 has a columnar shape. As a matter of course, specific configurations including the shape of the proximal portion 3 and the like are not limited.

The joints 4 are configured to be between the proximal portion 3 and the link 5 and between the links 5. Moreover, the joints 4 rotatably connect the members (the proximal portion 3 and the links 5) to each other.

In the present embodiment, the proximal portion 3 and a link 5a are connected to each other through a joint 4a. Typically, the proximal portion 3 is installed on an installation target surface. Then, the link 5a is rotatably connected to the proximal portion 3.

Moreover, the link 5a and the link 5b are rotatably connected to each other through a joint 4b.

Moreover, the link 5b and a link 5c are rotatably connected to each other through a joint 4c.

Driving the joints 4 rotates the links 5 so that joint angles (angles at which the connected members intersect with each other) can be arbitrarily controlled. As a matter of course, a possible joint angle range may be fixed.

The robot arm 1 includes the one or more joints 4 and one or more links 5. The one or more links 5 rotate or translate by driving each of the one or more joints 4.

In particular, in the present embodiment, each joint 4 are configured as a revolute joint that rotatably connects the members to each other.

The present technology is not limited thereto, and the joint 4 may be configured as a prismatic joint that connects the members to each other so that at least one member can translate. Moreover, the revolute joint and the prismatic joint may be both used as the joints 4.

That is, the present technology can be applied to any robot arm 1 whose link 5 rotates or translates by driving of each joint 4.

In addition, specific configurations of the joints 4 are not limited. It should be noted that the joints 4 will be generally referred to as joints or the like in some cases.

The links 5 function as members that connect the proximal portion 3 and the end effector 7 to each other.

The links 5a to 5c are configured to extend in one direction and their end portions are connected to the joints 4 or the end effector.

One end portion of the link 5a is connected to the joint 4a and the other end portion is connected to the joint 4b.

One end portion of the link 5b is connected to the joint 4b and the other end portion is connected to the joint 4c.

One end portion of the link 5c is connected to the joint 4c and the other end portion is connected to the end effector 7.

Specific shape, material, and the like of each link 5 are not limited, and may be arbitrarily designed.

The tactile sensor 6 is capable of detecting a contact state of an object with respect to the tactile sensor 6.

For example, the tactile sensor 6 is capable of detecting the presence/absence of contact of the object and a pressure (pressure value) that acts on the tactile sensor 6.

In a case where the tactile sensor 6 has a two-dimensional detection area with a predetermined area, it is also possible to detect a pressure distribution (distribution of pressure values) in the detection area. In this case, it is also possible to detect, on the basis of the pressure distribution, a contact position with respect to the detection area, for example. It should be noted that detection of the pressure distribution by the tactile sensor 6 is also included in the pressure detection.

In addition, the tactile sensor 6 is also capable of detecting a manipulation (e.g., stroke, grasp) with respect to the tactile sensor 6.

The tactile sensor 6 corresponds to an embodiment of a pressure sensor according to the present technology. A specific configuration of the tactile sensor 6 is not limited. Moreover, any pressure sensor other than the tactile sensor 6 may be used.

FIG. 1 schematically shows the tactile sensor 6 as rectangles. In the present embodiment, for example, sheet-like tactile sensors 6 attachable to curved surfaces are used. A tactile sensor 6a is attached to the link 5a. Similarly, a tactile sensor 6b is attached to the link 5b and a tactile sensor 6c is attached to the link 5c.

The tactile sensor 6 is provided at a position using the joint 4 of the robot arm 1 as a reference. That is, the tactile sensor 6 is set at a position where it is attached by using the position of the joint 4 as a reference.

Specifically, the tactile sensors 6 are provided at hold target regions 9 that are hold targets of the links 5 when an operator moves the links 5 with his or her hand 8.

The hold target regions 9 are typically assumed as regions easy for the operator to hold or regions that the operator holds with a high possibility.

It should be noted that for example, the operator's behavior of grasping the link 5 is included in the hold of the link 5.

A region suitable for the operator to hold the link 5 varies depending on, for example, a general configuration of the robot arm 1 and a distance by which the link 5 is moved. The hold target regions 9 may be set, for example, assuming positions where the operator will naturally hold them. Alternatively, the hold target regions 9 may be set, assuming positions enabling the operator to smoothly move the links 5.

Alternatively, the hold target regions 9 may be set by specifying them as regions that should be held without considering the operator's convenience and the like.

It should be noted that FIG. 1 schematically shows the hold target regions 9 (9a to 9c) as broken-line ellipses.

The tactile sensors 6 are provided in the set hold target regions 9.

In the present embodiment, the tactile sensor 6a is provided substantially at the center between the joints 4a and 4b by using the joints 4a and 4b as a reference. Similarly, the tactile sensor 6b is provided in a hold target region 9b and the tactile sensor 6c is provided in the hold target region 9c.

In a case where the operator wishes to move the link 5, the operator's hand (fingers) 8 comes into contact with the tactile sensor 6. Then, the tactile sensor 6 detects a contact state of the operator's hand 8.

Specific positions where the tactile sensors 6 are provided by using the joint 4 of the robot arm 1 as a reference and a method of determining positions where they are provided are not limited.

The end effector 7 is a mechanism for grasping the object, for example. In FIG. 1, the end effector 7 is schematically shown in a rectangular parallelepiped shape and is connected to one end portion of the link 5c.

For example, an arm is connected as the end effector 7. In this case, the end effector 7 can grasp and lift up the object. Alternatively, the end effector 7 may be provided with a mechanism of suctioning the object and may lift up the object by the mechanism suctioning it. In addition, the configuration of the end effector 7 is not limited, and the end effector 7 may be capable of performing any operation, e.g., attaching an object or polishing a curved surface.

The information processing apparatus 2 is constituted by any computer, e.g., a personal computer (PC).

The information processing apparatus 2 functions as an embodiment of an information processing apparatus according to the present technology. The information processing apparatus 2 executes an information processing method according to the present technology in accordance with a program according to the present technology.

As shown in FIG. 2, the robot arm 1 further includes a joint drive unit 12, a communication unit 13, a light emitting diode (LED) 14, a display 15, and a loudspeaker 16 (not shown in FIG. 1).

The joint drive unit 12 is a mechanism for driving the joints 4 and rotating the links 5.

A mechanism such as a spring or a damper system is configured as the joint drive unit 12 inside the joint 4 and driving of the joint 4 is realized by, for example, contraction and extension of the spring. In addition, any configuration such as a servo motor may be employed as the joint drive unit 12.

The communication unit 13 is a communication module for communicating with other devices via a network such as a WAN or a LAN. The communication unit 13 may include a communication module for near-field communication such as Bluetooth (registered trademark). Moreover, communication devices such as modem and router may be used. In the present embodiment, the communication unit 13 communicates with the information processing apparatus 2.

The communication unit 13 is built in, for example, a predetermined position of the robot arm 1. In addition, a specific configuration of the communication unit 13 is not limited.

The LED 14 is arranged on, for example, the surface of the link 5. In the present embodiment, the LED 14 is capable of emitting light in a predetermined color and is capable of informing a user of various types of information by using a difference in light emission color or a difference in color strength.

The LED 14 functions as a lighting device. In addition, any lighting device other than the LED 14, such as a lamp, may be used.

The display 15 is, for example, a display device using liquid-crystal electro luminescence (EL) or the like. The display 15 is arranged on, for example, the surface of the link 5. Various images, various graphical user interfaces (GUIs), and the like are displayed on the display 15 and the user is notified of various types of information.

In addition, any display device other than the display may be used.

The loudspeaker 16 is built in a predetermined position, for example, the proximal portion 3 of the robot arm 1. By outputting sounds from the loudspeaker 16, the user is notified of various types of information. A configuration of the loudspeaker 16 is not limited, and for example, the loudspeaker 16 capable of outputting stereo sounds, monaural sounds, or the like may be used as appropriate.

The LED 14, the display 15, the loudspeaker 16 constitute a notification unit that informs the user of various types of information. As a matter of course, a mechanism included in the notification unit is not limited, and any configuration capable of notifying the user of various types of information may be employed.

As shown in FIG. 2, the information processing apparatus 2 includes a controller 17, a storage unit 18, and a communication unit 19.

The controller 17 has hardware required for computer configurations such as a CPU, a ROM, a RAM, and an HDD. For example, by the CPU loading the program according to the present technology recorded in advance on the ROM or the like into the RAM and executing it, processing related to the information processing method according to the present technology is executed.

For example, a programmable logic device (PLD) such as a field programmable gate array (FPGA) or another device such as an application specific integrated circuit (ASIC) may be used as the controller 17.

The program is installed in the information processing apparatus 2 via various recording media, for example. Alternatively, the program may be installed via the Internet or the like. The type and the like of the recording medium on which the program is recorded is not limited, and any computer-readable recording medium may be used.

In the present embodiment, by the CPU of the controller 17 executing the program according to the present technology (e.g., an application program), a stiffness control unit 20 and a notification control unit 21 are realized as functional blocks.

Then, the information processing method according to the present embodiment is executed by these functional blocks. It should be noted that dedicated hardware such as an integrated circuit (IC) may be used as appropriate in order to realize the respective functional blocks.

The stiffness control unit 20 controls the stiffness regarding driving of the joint 4 of the robot arm 1.

The stiffness regarding driving of the joint 4 means resistance to driving of the joint 4 (magnitude of force required to drive the joint 4). It can also be said that the stiffness regarding driving of the joint 4 is the extent to which it resists driving of the joint 4.

For example, it is assumed that the stiffness is set to be relatively high. In this case, when a small force acts on the joint 4, the joint 4 is not driven, so the joint angle of the joint 4 and the position of the link 5 do not change. On the other hand, in a case where the stiffness is set to be relatively low, even when a small force acts the joint 4, the joint 4 is driven.

The stiffness control unit 20 is capable of setting the stiffness regarding driving of the joint 4 and changing the stiffness, e.g., increasing or decreasing the stiffness.

The notification control unit 21 controls notification of the stiffness set by the stiffness control unit 20.

Specifically, the notification control unit 21 controls the operations of the LED 14, the display 15, and the loudspeaker 16 of the robot arm 1.

By light emission by the LED 14, image display by the display 15, or audio output by the loudspeaker 16, the user is notified of the stiffness set by the stiffness control unit 20.

The storage unit 18 is a storage device such as a nonvolatile memory. For example, an HDD or an SSD is used as the storage unit 18. In addition, any computer-readable non-transitory storage medium may be used.

The communication unit 19 is a communication module for communicating with other devices as in the communication unit 13 of the robot arm 1. In the present embodiment, the communication unit 19 communicates with the robot arm 1.

A specific configuration of the communication unit 19 is not limited.

The configurations of the robot arm 1 and the information processing apparatus 2 described above with reference to FIGS. 1 and 2 are merely examples, and their specific configurations are not limited. Moreover, a specific configuration of the entire robot control system 100 is also not limited.

### [Direct Teaching Mode]

In the present embodiment, the operator is able to perform the direct teaching.

The direct teaching refers to processing in which the operator moves the robot arm 1 and stores a predetermined motion.

For example, a dedicated operator in charge of maintenance or the like for the robot control system 100 performs the direct teaching. As a matter of course, any user other than the operator may perform the direct teaching.

The operator makes a mode change to a direct teaching mode for performing the direct teaching.

The direct teaching mode refers to a mode for performing the direct teaching. That is, the direct teaching mode refers to a mode on which the operator moves the robot arm 1 and stores a predetermined motion.

Hereinafter, the direct teaching will be sometimes referred to as teaching.

Moreover, the direct teaching mode will be sometimes referred to as a teaching mode.

For example, pushing a mode change button provided to the robot arm 1 allows the teaching mode. Specifically, an instruction to start the teaching mode is sent to the information processing apparatus 2 from the robot arm 1.

In addition, any method may be used to start the teaching mode.

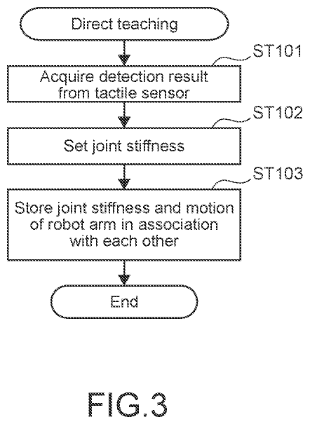

FIG. 3 is a flowchart showing basic processing examples on the direct teaching mode by the information processing apparatus 2.

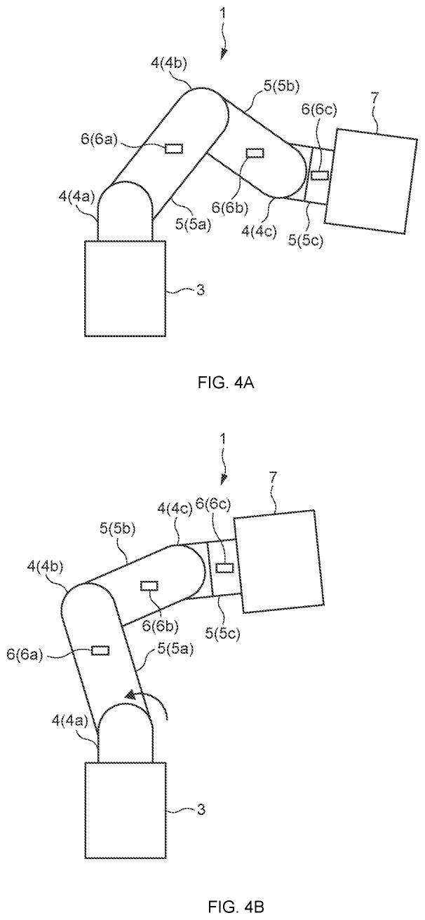

FIG. 4 is a schematic view showing an example of the motion of the robot arm 1 stored by the direct teaching.

In this example, it is assumed that the operator moves the robot arm 1 from the state in A of FIG. 4 to the state in B of FIG. 4.

Specifically, considering the state in A of FIG. 4 as an initial state, the joint 4a is driven, the link 5a is rotated on rearward (leftward in FIG. 4), and it is shift to the state in B of FIG. 4. B of FIG. 4 schematically shows a rotation direction of the joint 4a as a counter-clockwise arrow.

Moreover, the joints 4b and 4c also slightly rotate and a relative angle of the link 5b with respect to the link 5a and a relative angle of the link 5c with respect to the link 5b also change. As a whole of the robot arm 1, the mechanism on the distal side with respect to the link 5a rotates rearward and the end effector 7 largely moves upward (upward in FIG. 4).

Such a motion of the robot arm 1 is stored on the teaching mode. Specifically, a predetermined motion is stored by the operator grasping the robot arm 1 and making the robot arm 1 perform a predetermined motion. For example, for storing the motion shown in FIG. 4, the operator only needs to grasp the robot arm 1 and reproduce the same motion as in FIG. 4.

In the present embodiment, the operator grasps the link 5 and inputs the motion while touching the tactile sensor 6 with the operator's hand 8.

For example, in a case where the teaching mode is selected, the operator may be notified of an instruction to move the robot arm 1 while touching the tactile sensor 6. Specifically, the notification control unit 21 controls operations of the display 15 and the loudspeaker 16 and notifies the operator of the instruction by image display or audio output.

Hereinafter, the description will be made by exemplifying a case where the operator grasps a position near the center of the link 5a and inputs the motion shown in FIG. 4.

When the operator selects the teaching mode, the processing shown in FIG. 3 is executed.

The information processing apparatus 2 acquires a pressure detected by the tactile sensor 6a (Step 101).

The operator grasps the position near the center of the link 5a in the palm. At this time, a part of the palm is put in contact with the tactile sensor 6a. That is, the pressure acts on the tactile sensor 6a from the operator's palm and the tactile sensor 6 detects the pressure.

For example, when the link 5a is grasped with a relatively strong force, a relatively high pressure value is detected.

When the link 5a is grasped with a relatively weak force, a relatively low pressure value is detected.

Moreover, when a wide portion of the palm is in contact with the tactile sensor 6a, a wide pressure distribution is detected.

When a narrow portion of the palm is in contact with the tactile sensor 6a, a narrow pressure distribution is detected.

In addition, any information associated with the contact state may be detected.

In this manner, the pressure detected by the tactile sensor 6a is sent to the information processing apparatus 2 as a detection result. Specifically, the detection result is sent to the communication unit 19 of the information processing apparatus 2 via the communication unit 13 of the robot arm 1. Accordingly, the information processing apparatus 2 acquires the detection result.

### [Setting of Stiffness]

The stiffness control unit 20 sets the stiffness of the joint 4a (Step 102).

The stiffness control unit 20 controls the stiffness regarding driving of the joint 4a of the robot arm 1 on the basis of the detection result of the tactile sensor 6a.

Moreover, in the present embodiment, the stiffness control unit 20 controls the stiffness to increase along with an increase in pressure detected by the tactile sensor 6a.

Specifically, first of all, the stiffness control unit 20 acquires the detection result sent to the communication unit 19 of the information processing apparatus 2.

Then, the stiffness is calculated on the basis of the acquired detection result. For example, a function for stiffness calculation using the pressure value as an input and the stiffness as the output is used and the stiffness is calculated. A function (monotonic increasing function) by which the output stiffness increases as the input pressure value increases is used as the function for stiffness calculation. In other words, the output stiffness decreases as the input pressure value decreases.

Such a monotonic increasing function can be easily determined by a calibration process (calculation). For example, a function with which the pressure value is proportional to the stiffness is used as the monotonic increasing function. Alternatively, a function with which an increase rate of the stiffness varies depending on the pressure value may be used. In addition, any monotonic increasing function may be used.

In this manner, the stiffness of the joint 4a is set. It should be noted that the setting of the stiffness by the stiffness control unit 20 is included in the stiffness control.

As a matter of course, the present technology is not limited thereto, and any method may be used for the setting of the stiffness. For example, a method using a table or the like may be used to calculate the stiffness. Moreover, the relation between the pressure and the stiffness is also not limited to the relation in which the stiffness increases as the pressure value increases, and may be arbitrary.

In this manner, when the operator grasps the link 5a, the stiffness of the joint 4a is set. Similarly, the stiffness of the joint 4b is set when the operator grasps the link 5b. Moreover, the stiffness of the joint 4c is set when the operator grasps the link 5c.

The set stiffness of the joint 4a and the motion of the robot arm 1 are stored in association with each other (Step 103).

In the present embodiment, the storage unit 18 stores the stiffness set by the stiffness control unit 20 and the motion of the robot arm 1 by driving of the joint 4 in association with each other.

For example, when the operator grasps the link 5a with a predetermined force, it is assumed that the stiffness of the joint 4a set by the stiffness control unit 20 is “50”. In addition, it is assumed that the “motion shown in FIG. 4”, which is the motion of the robot arm 1 by driving of the joint 4, is input with the grasp force kept at the same magnitude (predetermined magnitude).

In this case, the stiffness “50” and the “motion shown in FIG. 4” are associated with each other and stored in the storage unit 18.

It should be noted that the value of the stiffness “50” is merely an example, and the value of the stiffness and the unit for the value of the stiffness may be arbitrary.

Moreover, also when the force of grasping the link 5a changes during the grasp, the stiffness and the motion are stored in association with each other.

For example, a case where the force of grasping the link 5a changes in an “intermediate state” between the state in A of FIG. 4 and the state in B of FIG. 4 will be considered. The “intermediate state” refers to a just intermediate state between the state in A of FIG. 4 and the state in B of FIG. 4. For example, a state in which the joint 4a has rotated by a half of the angle of rotation from the state in A of FIG. 4 to the state in B of FIG. 4 corresponds to the “intermediate state.” The same applies to the other joints 4.

The operator grasps the link 5a with a relatively strong force for inputting the motion “A of FIG. 4→intermediate” (motion to the intermediate state from the state in A of FIG. 4). Accordingly, for example, the stiffness “70” that is relatively high stiffness is set.

Then, the stiffness “70” and the motion “A of FIG. 4→intermediate” are associated with each other and stored in the storage unit 18.

Moreover, the operator grasps the link 5a with a relatively weak force for inputting the motion “intermediate→B of FIG. 4”. Accordingly, for example, the stiffness “30” that is relatively low stiffness is set.

Then, the stiffness “30” and the motion “intermediate→B of FIG. 4” are associated with each other and stored in the storage unit 18.

### [Driving of Robot Arm]

In the present embodiment, the robot arm 1 is capable of being driven on the basis of the stiffness and the motion stored in the storage unit 18.

For example, it is assumed that the storage unit 18 has stored “the stiffness ‘70’ and the motion ‘A of FIG. 4→intermediate’” and “the stiffness ‘30’ and the motion ‘intermediate→B of FIG. 4’”. In this case, the robot arm 1 is driven to perform the motion of “A of FIG. 4→intermediate” with the stiffness “70” and perform the motion “intermediate→B of FIG. 4” with the stiffness “30”.

In order to realize such driving, the stiffness control unit 20 controls the stiffness regarding rotation or translation of the one or more links 5.

In particular, in the present embodiment, the joints 4a to 4c are all configured as revolute joints, and therefore the stiffness regarding rotation of the three links 5a to 5c is controlled. The stiffness regarding rotation of the link 5 refers to the resistance to the rotation of the joint 4 (the extent to which it resists the rotation of the joint 4).

The stiffness regarding rotation of the link 5 is controlled by the stiffness control unit 20 controlling the state of the mechanism such as the spring or the damper system that constitutes the joint drive unit 12 to change driving torque. For example, the stiffness control unit 20 controls the position of the spring, such that the pressure from the spring changes.

Accordingly, frictional forces acting on various mechanisms of the joint drive unit 12 change and the magnitude of force required to drive the joints 4 also change. Therefore, the resistance to the rotation of the joint 4 changes.

As a matter of course, a control method for specific stiffness by the stiffness control unit 20 is not limited.

When the stiffness regarding rotation of the link 5 is controlled, a degree of influence of an external impact on the motion of the robot arm 1 also changes.

For example, in a case where the stiffness regarding rotation is relatively high, the rotation of the joint 4 is not easily prohibited even when an external impact is added while the robot arm 1 is driven. That is, the motion of the robot arm 1 is unlikely to be affected, and the robot arm 1 performs motion different from the stored motion with a low possibility.

On the other hand, in a case where the stiffness is relatively low, the rotation of the joint 4 is easily prohibited when an external impact is added. Therefore, the motion of the robot arm 1 is likely to be affected, and the robot arm 1 performs motion different from the stored motion with a high possibility.

In the present embodiment, the motion “A of FIG. 4→intermediate” of the series of “motion shown in FIG. 4” is performed with relatively high stiffness. Therefore, even when an external impact is added, the motion of the robot arm 1 is relatively unlikely to be affected.

On the other hand, the motion “intermediate→B of FIG. 4” is performed with relatively low stiffness. Therefore, the motion of the robot arm 1 is relatively likely to be affected by an external impact.

It should be noted that in a case where the joints 4 include a prismatic joint, the stiffness regarding translation of the link 5 is controlled. The stiffness regarding translation of the link 5 refers to resistance to the translation of the joint 4 (the extent to which it resists the translation of the joint 4).

Also in this case, the stiffness control unit 20 controls the state of the mechanism such as the spring or the damper system that constitutes the joint drive unit 12. For example, the stiffness control unit 20 controls the position of the spring, such that the pressure from the spring changes.

Moreover, the setting of the stiffness of the joint 4 that is the revolute joint by the stiffness control unit 20 in the teaching is also included in the control on the stiffness regarding rotation of the link 5.

The setting of the stiffness of the joint 4 that is the prismatic joint by the stiffness control unit 20 is also included in the control on the stiffness regarding translation of the link 5.

In order for the operator to easily input motion at the time of the teaching, the force required to move the robot arm 1 may be reduced. Specifically, for example, at the same time a mode change to the teaching mode is made, the stiffness control unit 20 may control the stiffness of the joint 4 regarding rotation or translation to be low.

Hereinabove, in the information processing apparatus 2 according to the present embodiment, the stiffness regarding driving of the joint 4 of the robot arm 1 is controlled on the basis of the detection result of the tactile sensor 6. Accordingly, the robot arm 1 can be accurately driven.

Robot arms are widely used as industrial robots for performing predetermined tasks in a factory or the like. The robot arms are designed to be capable of performing various operations such as lifting up and moving an object, attaching an object, and polishing a curved surface, and they often involve physical contact of end effectors (e.g., arms) with target objects.

It is desirable that the robot arm be accurately driven on the basis of motion set (taught) by the operator or the like in order to accurately perform the predetermined task. Therefore, basically, the stiffness is controlled to be high while the robot arm is moving. Accordingly, the robot arm can be prevented from performing unexpected motion.

However, in a scene where the end effector of the robot arm is in contact with the target object, if the stiffness of the robot arm is controlled to be high, it applies a strong force to the target object. Specifically, even when the robot arm comes into contact with the target object and a normal force is applied from the target object, the robot arm continues to be driven without changing the set motion. Therefore, for example, the end effector is pushed in the target object and break the target object in some cases.

In order to prevent that, it is desirable that the stiffness be controlled to be low as long as the end effector is held in contact with the target object or as long as the end effector is located near the target object. Accordingly, it is possible to configure “soft control” to cope with the force when the normal force from the target object acts on the end effector.

A possible method for setting the stiffness with respect to each motion of the robot arm is, for example, a method using a remote controller. In this case, for example, it is a method in which switches respectively corresponding to the joints are provided and the stiffness is set on the basis of a total number of pushes on the switch of the joint whose stiffness is wished to be set.

However, in this method, it is difficult to achieve fine setting of the stiffness while setting the motion, and it applies a heavy burden on the operator.

In the present embodiment, the operator is able to simultaneously set the stiffness while inputting the motion, and therefore the operator's labor associated with the input of the motion and the setting of the stiffness is reduced.

For example, in order to safely perform a task involving the contact with the target object, the stiffness is set to be high for the first 4/5 of the motion of the robot arm (when the end effector is located away from the target object) and the stiffness is set to be low for the remaining 1/5 (when the end effector is located near the target object). Such a complicated setting of the stiffness can also be easily made.

In addition, in the present embodiment, the tactile sensor is provided in a region that is a hold target of the link when the operator moves the link.

The tactile sensor is provided in a region suitable for the operator to hold the link, e.g., a region easy for the operator to hold or a region that the operator holds with a high possibility.

Accordingly, manipulability when the operator inputs the motion of the robot arm is enhanced. Moreover, the tactile sensor accurately detects the pressure.

Moreover, the stiffness control unit controls the stiffness to increase the stiffness along with an increase in pressure detected by the tactile sensor. For example, when the operator tightly grasps the link, the stiffness is set to be relatively high.

Accordingly, the operator is able to intuitively set the stiffness.

Moreover, the stiffness control unit controls stiffness regarding rotation or translation of the one or more links.

That is, the stiffness can be controlled in any case of a case where all joints are configured as revolute joints, a case where all joints are configured as prismatic joints, and a case where all joints are configured as revolute joints and prismatic joints.

Accordingly, a suitable joint configuration can be employed on the basis of the contents and the like of the task executed by the robot arm.

### Second Embodiment

A robot control system 100 according to a second embodiment of the present technology will be described.

Hereinafter, descriptions of portions similar to the configuration and actions in the robot control system 100 described in the above embodiment will be omitted or simplified.

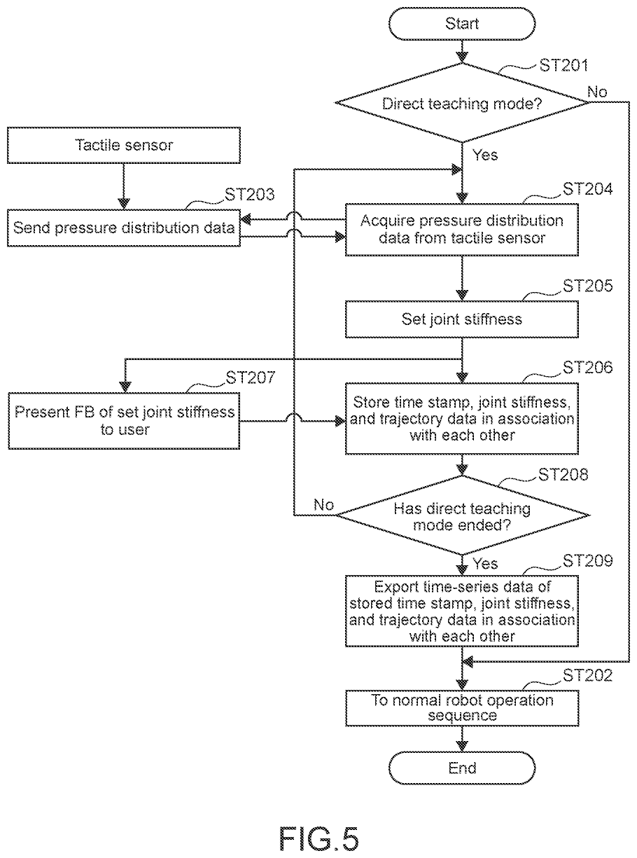

FIG. 5 is a flowchart showing a processing example on the direct teaching mode by the information processing apparatus 2.

Whether or not the mode of the robot arm 1 is the direct teaching mode is determined (Step 201).

In a case where the mode of the robot arm 1 is not the direct teaching mode (No in Step 201), a driving mode on which the robot arm 1 is driven is selected on the basis of the contents of the teaching. On the driving mode, a normal robot operation sequence is executed (Step 202).

### [Trajectory Data]

In a case where the mode of the robot arm 1 is the teaching mode, the operator inputs the motion.

In the present embodiment, the operator inputs a track of the robot arm 1 and trajectory data is generated on the basis of the input track.

It should be noted that the track of the robot arm 1 is included in the motion of the robot arm 1.

The trajectory data is data indicating the position of each part of the robot arm 1. For example, a predetermined orthogonal coordinate system (XYZ coordinate system) is set by using the proximal portion 3 or the like as a reference. Then, the position information “X: 100, Y: 200, Z: 300” of the link 5 is generated as the trajectory data.

The trajectory data may be expressed by any other coordinate system such as a polar coordinate system. Moreover, the trajectory data may be expressed by the position of the joint 4 or the end effector 7 or the joint angle of the joint 4.

The trajectory data is generated by, for example, the stiffness control unit 20 of the information processing apparatus 2. The present technology is not limited thereto, and dedicated functional blocks may be configured.

### [Pressure Distribution Data]

In the present embodiment, the tactile sensor 6 generates pressure distribution data.

Hereinafter, details of the pressure distribution data will be described.

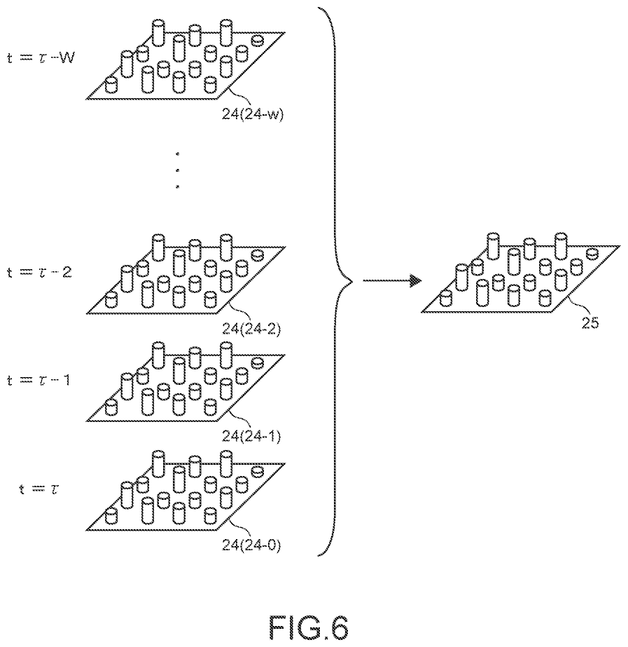

FIG. 6 is a schematic view showing an example of averaging processing for the pressure distribution data.

The pressure distribution data refers to a distribution of pressure values in each position on the tactile sensor 6.

In the present embodiment, for example, a plurality of pressure detection points (sensor nodes) is arranged in a grid form within the detection area of the tactile sensor 6 and detects pressure values acting on respective detection points.

FIG. 6 schematically shows pressure distribution data 24. In the example of FIG. 6, for the tactile sensor 6, four (vertical) and four (horizontal) pressure detection points are arranged in a grid form. In addition, the pressure values acting on the respective pressure detection points are schematically represented by bar heights. For example, a relatively high bar means that the pressure value detected by the pressure detection point is relatively high.

In addition, any arrangement other than the grid arrangement may be employed as arrangement of the pressure detection points. For example, a band-type tactile sensor 6 may be employed and pressure detection points may be arranged in a one-dimensional linear form.

Moreover, the number of pressure detection points arranged is also not limited.

In a case where the pressure detection points are arranged in a grid form, for example, pressure values respectively detected at the pressure detection points are converted in a two-dimensional matrix and generated as the pressure distribution data 24. Specifically, the respective pressure detection points correspond to positions in the two-dimensional matrix (values of row number and column number) and the pressure values correspond to values of elements at those positions.

Moreover, in a case where the pressure detection points are arranged in a one-dimensional linear form, for example, the pressure values are converted into a mere numerical sequence and generated as the pressure distribution data 24.

In addition, a specific form of the pressure distribution data 24 generated by the tactile sensor 6 is not limited.

For example, when the operator strongly pushes the center of the tactile sensor 6 when the operator inputs a track, relatively high pressure values are detected at pressure detection points arranged near the center. On the other hand, relatively low pressure values are detected at pressure detection points arranged in a portion apart from the center, such as four corners of the tactile sensor 6.

As described above, in the present embodiment, pressure values of the respective pressure detection points are detected and generated as the pressure distribution data 24 rather than merely detecting a single value as a pressure value. That is, the contact state of the operator's hand 8 with respect to the tactile sensor 6 can be more finely reflected to the detection result.

The pressure distribution data 24 corresponds to an embodiment of the detection result of the tactile sensor 6 according to the present technology.

The pressure distribution data 24 generated by the tactile sensor 6 is sent to the information processing apparatus 2 (Step 203).

Specifically, the pressure distribution data 24 is sent to the communication unit 19 of the information processing apparatus 2 via the communication unit 13 of the robot arm 1.

Then, in a case where the mode of the robot arm 1 is the direct teaching mode (Yes in Step 201), the information processing apparatus 2 acquires the pressure distribution data 24 (Step 204).

As shown in FIG. 5, in the present embodiment, the processing of Steps 204 to 208 is repeated. Specifically, the processing is repeated so that one cycle of the processing of Steps 204 to 208 is performed for several tens of milliseconds.

Therefore, the acquisition of the pressure distribution data 24 in Step 204 is also executed in one cycle for several tens of milliseconds.

Moreover, in Step 204, the information processing apparatus 2 outputs an instruction to send the pressure distribution data 24 to the tactile sensor 6. Then, triggered by the instruction, the pressure distribution data 24 in Step 203 is sent. Therefore, Step 203 is executed at the same time (same cycle) as

### Step 204.

The cycle in which the tactile sensor 6 sends the pressure distribution data 24 is not limited.

The cycle in which the information processing apparatus 2 acquires the pressure distribution data 24 is not limited.

Moreover, the cycle in which the tactile sensor 6 generates the pressure distribution data 24 is also not limited. For example, the pressure distribution data 24 by the tactile sensor 6 may be generated in a relatively short cycle and the pressure distribution data 24 may be sent or acquired in a relatively long cycle. In this case, the information processing apparatus 2 acquires a plurality of pieces of pressure distribution data 24 accumulated by the tactile sensor 6 at a time.

In addition, a suitable processing cycle may be employed on the basis of the performance of the tactile sensors 6, for example.

Specific timing for generating, sending, and acquiring the pressure distribution data 24 is also not limited.

For example, the pressure distribution data 24 may be generated, sent, and acquired only while the operator's hand 8 touches the tactile sensor 6.

The information processing apparatus 2 may acquire lower-order information from the tactile sensor 6 (e.g., physical quantity such as voltage detected by the tactile sensor 6) and generate the pressure distribution data 24 on the basis of the acquired information.

### [Averaging Processing]

In the present embodiment, the averaging processing for the pressure distribution data 24 is executed.

Details of the averaging processing will be described.

FIG. 6 schematically shows instantaneous pressure distribution data 24 acquired at each time t.

Specifically, pressure distribution data 24-0 acquired at a time τ is shown.

Similarly, pressure distribution data 24-1 acquired at a time τ−1, pressure distribution data 24-2 acquired at a time τ−2, and pressure distribution data 24-w acquired at a time τ−W are shown.

For example, in a case where the pressure distribution data 24 is acquired for every 20 milliseconds, the pressure distribution data 24-1 is information acquired 20 milliseconds before the pressure distribution data 24-0. Similarly, the pressure distribution data 24-2 is information acquired 20 milliseconds before the pressure distribution data 24-1.

The time at which each piece of pressure distribution data 24 is acquired depends on the cycle of acquisition in this manner. However, considering one cycle of acquisition as a unit, the time is represented as a time τ, a time τ−1, and so on.

In the averaging processing, averaged average pressure distribution data 25 is generated on the basis of the plurality of pieces of pressure distribution data 24 acquired in a certain time in the past.

In the example of FIG. 6, the average pressure distribution data 25 is generated on the basis of a plurality of pieces of pressure distribution data 24 acquired between the time τ to the time τ−W.

For example, an average value of respective pressure values at pressure detection points in the same position on the plurality of pieces of pressure distribution data 24 is calculated. Specifically, in a case where the pressure values at the pressure detection points in the position “row: 1, column: 2” on each piece of pressure distribution data 24 are “30,” “50,” “70,” the pressure value at the position “row: 1, column: 2” on the average pressure distribution data 25 is “50”.

In this manner, the pressure value at each position on the average pressure distribution data 25 is calculated and the average pressure distribution data 25 is generated.

Moreover, a predetermined threshold may be set and only pressure values above (or below) the threshold may be used for calculation of the average value.

In addition, how the average pressure distribution data 25 is generated is not limited.

The averaging processing can cancel noise in the data.

For example, due to erroneous detection or the like of the tactile sensor 6, part of the pressure distribution data 24 has extreme outliers in some cases. Also in such a case, the averaging suppresses the influence of the outliers.

In the present embodiment, the information processing apparatus 2 generates the average pressure distribution data 25 after the pressure distribution data 24 is acquired in Step 204. The present technology is not limited thereto, and for example, the average pressure distribution data 25 may be generated in advance at the tactile sensor 6 and may be sent to the information processing apparatus 2 in Step 203.

In this case, the average pressure distribution data 25 corresponds to an embodiment of the detection result of the tactile sensor 6 according to the present technology.

The stiffness control unit 20 sets the stiffness of the joint 4 (Step 205).

First of all, the stiffness control unit 20 calculates the stiffness on the basis of the acquired detection result. Specifically, the stiffness is calculated on the basis of the average pressure distribution data 25.

Specifically, an average value of pressure values at all positions of the average pressure distribution data 25 is calculated. For example, the average pressure distribution data is constituted by two rows and two columns.

Then, an average value “25” in a case where the pressure value “row: 1, column: 1” is “10”, the pressure value “row: 1, column: 2” is “20”, the pressure value “row: 2, column: 1” is “30”, and the pressure value “row: 2, column: 2” is “40” is calculated.

Then, the stiffness is calculated with the function for stiffness calculation using the calculated average value as the input and the stiffness as the output. As the function for stiffness calculation, a monotonic increasing function is used as in the first embodiment. As a matter of course, any method such as a method using another function, a method using a table, or a method not calculating an average value of the average pressure distribution data 25 may be used for calculating the stiffness.

Time stamps, set stiffness of the joint 4, and generated trajectory data of the link 5 are stored in association with each other (Step 206).

In the present embodiment, the storage unit 18 stores the stiffness set by the stiffness control unit 20 and the track of the link 5 by driving of the joint 4 in association with each other.

For example, it is assumed that the set stiffness of the joint 4 is “50” in a state in which the position of the link is “X: 100, Y: 200, Z: 300”. In this case, the stiffness “50” and the trajectory data “X: 100, Y: 200, Z: 300” are stored in association with each other.

The trajectory data corresponds to an embodiment of the track of the link 5 by driving of the joint 4 according to the present technology. A track of each link 5 is determined by driving of each joint 4 (a change in joint angle). Then, the trajectory data is information indicating the track of the link 5 as position information.

In addition, in the present embodiment, the time stamp is stored in association with the stiffness and the trajectory data.

The time stamp refers to information indicating the time at which the robot arm 1 enters a certain state. For example, a numeric value indicating the time, e.g., “t=τ” shown in FIG. 6 is used as the time stamp.

For example, in a case where in a state in which the position of the link 5 is “X: 100, Y: 200, Z: 300”, the set stiffness of the joint 4 is “50” and the time at which it enters the state is “t=τ”, a set of three pieces of data, the time stamp “t=τ”, the stiffness “50”, and the trajectory data “X: 100, Y: 200, Z: 300”, is stored.

It should be noted that in Step 206, the set of the three pieces of data is temporarily stored in a buffer in the storage unit 18.

In the present embodiment, in this manner, detailed information regarding the motion of the robot arm 1 is stored, and therefore the robot arm 1 can be more accurately driven.

### [Notification of Stiffness]

The set stiffness of the joint 4 is presented to the user (Step 207).

For example, by notifying the operator of the set stiffness, feedback (FB) to the operator is made.

In the present embodiment, the notification control unit 21 controls notification of the stiffness set by the stiffness control unit 20. The notification of the stiffness is executed by using, for example, a presentation device installed in the link 5.

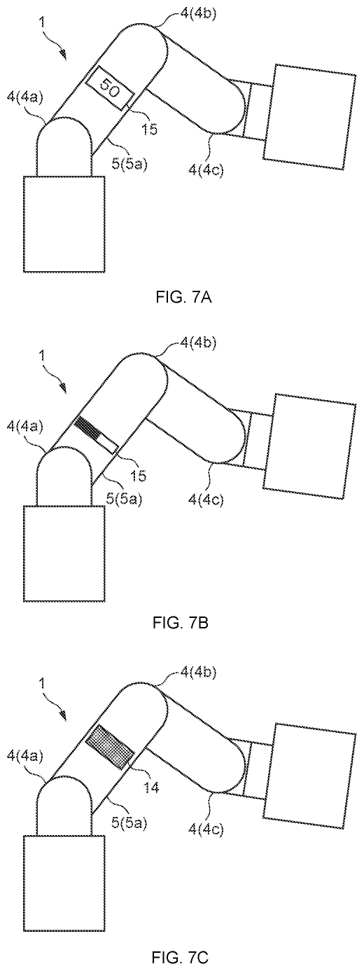

FIG. 7 is a schematic view showing an example of the notification control on the stiffness by the notification control unit 21.

A of FIG. 7 shows a state in which the value of the stiffness is displayed on the display 15.

B of FIG. 7 shows a state in which a gauge is displayed on the display 15.

C of FIG. 7 shows a state in which the LED 14 is emitting light.

In the present embodiment, the notification control unit 21 controls at least one of display of the value of the stiffness, display of the gauge according to the level of the stiffness, display of the color according to the level of the stiffness, or audio output of the stiffness.

The notification of the level of the stiffness is performed in real time by, for example, displaying the set value of the stiffness during the teaching.

Moreover, when the robot arm 1 is driven, the notification of the level of the stiffness may be performed.

In A of FIG. 7, the value of the stiffness “50” is displayed on the compact display 15.

Specifically, the display 15 provided to the link 5a displays the value of the stiffness “50” of the joint 4a. The present technology is not limited thereto, and the stiffness of the three joints 4a to 4c may be displayed on the display 15 at the same time.

Alternatively, the level of the stiffness may be displayed stepwisely, e.g., “large,” “medium,” and “small”.

In B of FIG. 7, the gauge is displayed on the display 15.

For example, using the value of the stiffness “100” as an upper limit, the gauge with a length according to the stiffness is displayed. In the example shown in B of FIG. 7, the value of the stiffness is about “50” because the length of the gauge is substantially a half of the upper limit.

The value of the stiffness may be indicated by a meter such as a speedometer.

In C of FIG. 7, the LED 14 is emitting light in a predetermined color.

The LED 14 emits light in a color according to a level of the stiffness. For example, the LED 14 emits light in different colors in accordance with levels of the stiffness:
green in a case where the value of the stiffness is “0 to 30”;
blue in a case where the value of the stiffness is “31 to 70”; and
red in a case where the value of the stiffness is “71 to 100”.

Alternatively, the light emission by the LED 14 may be controlled so that the display color strength varies in accordance with the level of the stiffness. For example, control may be performed to cause the LED 14 to emit light strongly (darker) in a case where the stiffness is relatively high and to cause the LED 14 to emit light weakly (softer) in a case where the stiffness is relatively low.

Moreover, the audio output of the stiffness by the loudspeaker 16 may be performed.

For example, the voice “the current stiffness is 50” is output so that the operator is notified of the stiffness.

Accordingly, the operator is able to know the value of the stiffness and determine whether the link 5 should be grasped more tightly or softly in order to set the stiffness to a desired level.

Moreover, the operator is able to intuitively know the level of the stiffness by the gauge display or the like.

It should be noted that notification of the contents of the trajectory data and the time stamp as well as the stiffness may be performed as information including the stiffness. For example, the value of the stiffness, the position of the link 5, and the time may be displayed on the display 15 together.

Moreover, in the present embodiment, the notification control unit 21 sets the stiffness for the teaching when the operator moves the link 5 and performs the teaching in accordance with the stiffness set by the stiffness control unit 20.

Specifically, the stiffness of the joint 4 changes in real time while the operator is moving the link 5 on the teaching mode. That is, the force required for the operator to move the link 5 at the time of the teaching changes, e.g., increases or decreases.

The stiffness is changed by the notification control unit 21 setting the stiffness and the stiffness control unit 20 controlling the stiffness on the basis of the set stiffness.

In the present embodiment, in particular, the notification control unit 21 sets the stiffness for the teaching to increase along with an increase in stiffness set by the stiffness control unit 20.

That is, when the operator tightly grasps the link 5 and the set stiffness is relatively high during the teaching, the stiffness for the teaching is controlled to be relatively high and the force required for the operator to move the link 5 increases. Accordingly, the operator feels the joint 4 and the link 5 have stiffened.

On the other hand, when the operator softly grasps the link 5 and the set stiffness is relatively low, the force required for the operator to move the link 5 decreases. Accordingly, the operator feels the joint 4 and the link 5 have softened.

Accordingly, the operator is able to intuitively know the set level of the stiffness and perform the teaching. For example, there is a case where the operator wishes to set the stiffness to be lower, but the operator feels the link 5 have stiffened. In this case, the operator is able to consider that the stiffness has been set to be higher and take a measure, e.g., reduce the force of grasping the link 5.

Moreover, it is possible to know the level of the stiffness only by sense of touch. Thus, it is possible to know the level of the stiffness more intuitively.

In the teaching, the set stiffness and the stiffness for the teaching may be equal or may be different, for example, may be proportional to each other.

Moreover, the relation between the set stiffness and the stiffness for the teaching does not need to be limited to a relation in which the stiffness for the teaching increases as the set stiffness increases, and may be arbitrary.

In addition, any method may be used to control the notification of the stiffness.

Whether or not the direct teaching mode has ended is determined (Step 208).

In a case where the direct teaching mode has been executed (No in Step 208), the pressure distribution data 24 is acquired again (Step 204).

In a case where the direct teaching mode has ended (Yes in Step 208), time-series data of the stored time stamp, stiffness, and the trajectory data is exported (Step 209).

In Step 206, the set of the time stamp, the stiffness, and the trajectory data is temporarily stored in the buffer in the storage unit 18. The processing in Step 206 is repeated multiple times while the teaching mode is executed, and therefore a plurality of data sets is accumulated in the buffer.

In Step 209, the data sets accumulated in the buffer are exported as the time-series data. The time-series data refers to data in which the data sets are arranged on the time axis. In the present embodiment, the data sets are rearranged in accordance with the values of the time stamps and exported as the time-series data.

For example, in a case where the data sets:
the time stamp “t=3”, the stiffness “70”, the trajectory data “X: 300”;
the time stamp “t=1”, the stiffness “50”, the trajectory data “X: 100”; and
the time stamp “t=2”, the stiffness “60”, the trajectory data “X: 200”
have been accumulated in the buffer, they are rearranged in an increasing order of the value of the time stamp, the following time-series data is exported:
the time stamp “t=1”, the stiffness “50”, the trajectory data “X: 100”;
the time stamp “t=2”, the stiffness “60”, the trajectory data “X: 200”; and
the time stamp “t=3”, the stiffness “70”, the trajectory data “X: 300”.

That is, it can also be said that the time-series data is data in which values of the stiffness of the joint 4 and positions of the link 5 are arranged in chronological order.

After the time-series data is exported, the normal robot operation sequence is executed on the driving mode (Step 202). Specifically, the robot arm 1 is driven in accordance with the exported time-series data.

It should be noted that Step 204 (acquisition of the pressure distribution data 24) is processing corresponding to Step 101 in FIG. 3 (acquisition of the detection result).

Step 205 (setting the stiffness) is processing corresponding to Step 102 (setting of the stiffness).

Step 206 (storing the time stamp, the stiffness, and the trajectory data in association with each other) is processing corresponding to Step 103 (storing the stiffness and the motion of the robot arm 1 in association with each other).

### Third Embodiment

A robot control system 100 according to a third embodiment of the present technology will be described.

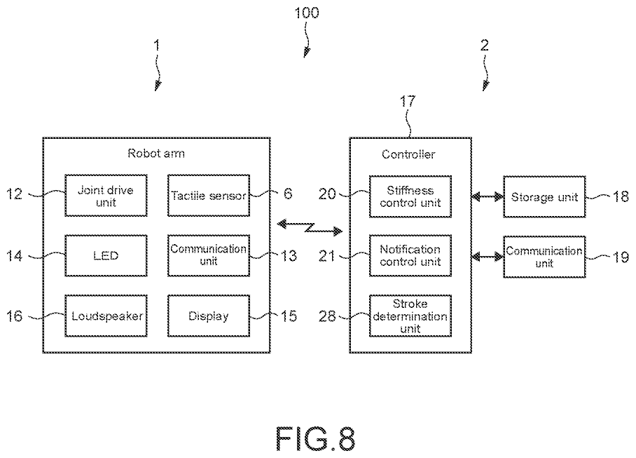

FIG. 8 mainly shows functional configuration examples of the robot control system.

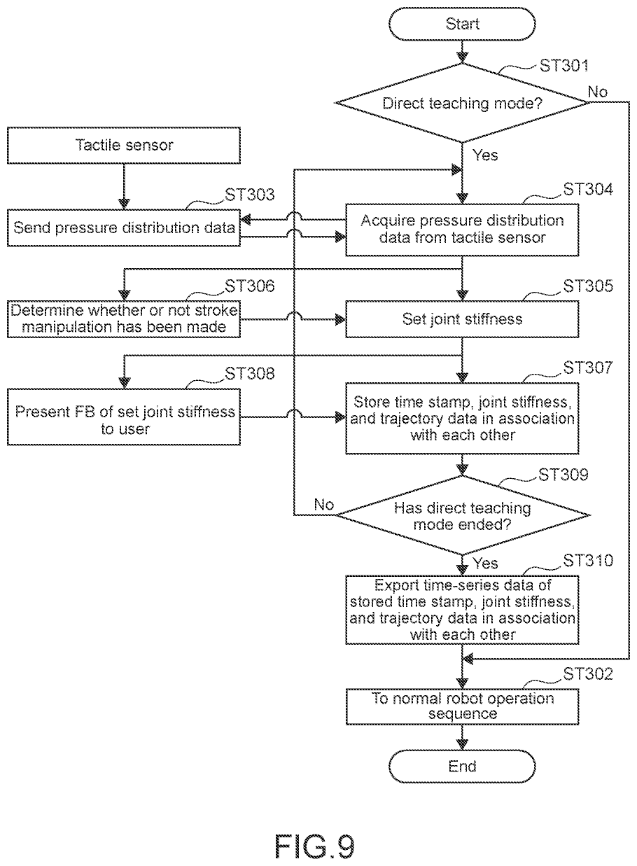

FIG. 9 is a flowchart showing a processing example on the direct teaching mode by the information processing apparatus 2.

As shown in FIG. 8, in the present embodiment, the controller 17 of the information processing apparatus 2 configures a stroke determination unit 28.

The stroke determination unit 28 is realized as the functional block by the CPU of the controller 17 executing the program according to the present technology.

The stroke determination unit 28 determines whether or not the stroke manipulation has been made on the tactile sensor 6.

Moreover, what kind of stroke manipulation has been made with respect to the tactile sensor 6 is determined.

In Steps 301 to 304 of FIG. 9, the processing similar to that in the second embodiment is executed.

The stiffness control unit 20 sets the stiffness of the joint 4 (Step 205).

### [Retaining of Pressure Value]

In the present embodiment, the stiffness control unit 20 retains a maximum value of a pressure detected by the tactile sensor 6.

On the teaching mode, the generation of the average pressure distribution data 25 is repeated. The stiffness control unit 20 retains a maximum value among a plurality of pieces of average pressure distribution data 25 generated during the period from the time of starting the teaching mode to the current time.

For example, an average value of pressure values in each position on the average pressure distribution data 25 is calculated and a maximum value among the calculated average values is retained.

As an example, a case where the following average values are calculated in order from the time of starting the teaching mode will be considered:
at the time “t=1”, the average value “50”;
at the time “t=2”, the average value “40”; and
at the time “t=3”, the average value “60”.

In this case, first of all, at the time “t=1”, no average values have been calculated so far, and therefore “50” is retained as the maximum value. The maximum value “50” is retained (latched) by, for example, substituting “M=50” for a variable M for retaining the maximum value.

Next, at the time “t=2”, the currently retained maximum value “M=50” is higher than the calculated average value “40” at “t=2”, and therefore the maximum value is not updated and “M=50” is continuously retained as the maximum value.

Next, at the time “t=3”, the calculated average value “60” has exceeded the currently retained maximum value “M=50” at “t=3”, and therefore the maximum value is updated and “M=60” is newly retained as the maximum value.

That is, a pressure value when the operator grasped the link 5 with the largest force during the period from the time of starting the teaching mode to the current time is retained as the maximum value.

The maximum value among the plurality of pieces of average pressure distribution data 25 generated during the period from the time of starting the teaching mode to the current time corresponds to an embodiment of the maximum value of the pressure detected by the pressure sensor according to the present technology.

Moreover, the stiffness control unit 20 sets the stiffness according to the retained maximum value. Specifically, the stiffness control unit 20 sets the stiffness to increase as the maximum value increases
in accordance with the maximum value “M=50” at the time “t=1”,
in accordance with the maximum value “M=50” at the time “t=2”, and
in accordance with the maximum value “M=60” at the time “t=3”.

That is, when the operator tightly grasps the link 5 once, the stiffness is set to be high at all times thereafter. For example, even if the operator reduces the force of grasping the link 5 thereafter, the maximum value retained by the stiffness control unit 20 does not change, and the stiffness is thus kept high.

In this manner, it can also be said that the stiffness control unit 20 retains the maximum value of the stiffness.

In the present embodiment, the operator is able to set the stiffness of the joint 4a by grasping the link 5a. Similarly, the operator is able to set the stiffness of the joint 4b by grasping the link 5b and set the stiffness of the joint 4c by grasping the link 5c.

For example, there can be a case where one operator wishes to simultaneously input motion while setting the stiffness of the three joints 4a to 4c. The operator is able to simultaneously set the stiffness of at most two joints 4 because the operator is able to grasp at most two links 5.

Since the stiffness control unit 20 retains the maximum pressure value, the operator is able to input the motion while setting the stiffness of the three joints 4a to 4c.

For example, first of all, the operator grasps the link 5a and sets the stiffness of the joint 4a to “50”.

Then, the operator moves the hand away from the link 5a without moving the robot arm 1.

At that time, since the stiffness of the joint 4a is retained, the stiffness of the joint 4a does not return to “0” when the operator moves the hand away from it.

Next, the operator grasps the links 5b and 5c and moves the robot arm 1. Accordingly, for example, the stiffness of the joint 4b is set to “40”. Moreover, the stiffness of the joint 4c is set to “60”. In addition, the motion is input.

Finally, three levels of the stiffness “50,” “40,” and “60” of the joints 4a to 4c and the motion of the robot arm 1 have been input.

Accordingly, even in a case where the robot arm 1 has three or more links 5, one operator is able to set the stiffness of all the joints 4. Even if the robot arm 1 has a complicated mechanism including a number of links 5 and a number of joints 4, one operator is able to easily perform the teaching and many operators are not required. That is, labor and human resources associated with the teaching are saved.

### [Stroke Manipulation]

The stroke determination unit 28 determines whether or not the stroke manipulation has been made on the tactile sensor 6 (Step 306).

In the present embodiment, the stiffness control unit 20 decreases the stiffness in a case where a predetermined manipulation has been input to the tactile sensor 6.

In addition, the predetermined manipulation with respect to the tactile sensor 6 includes the stroke manipulation.

That is, in a case where the stroke manipulation has been made on the tactile sensor 6, the setting of the stiffness is performed to decrease the stiffness of the joint 4.

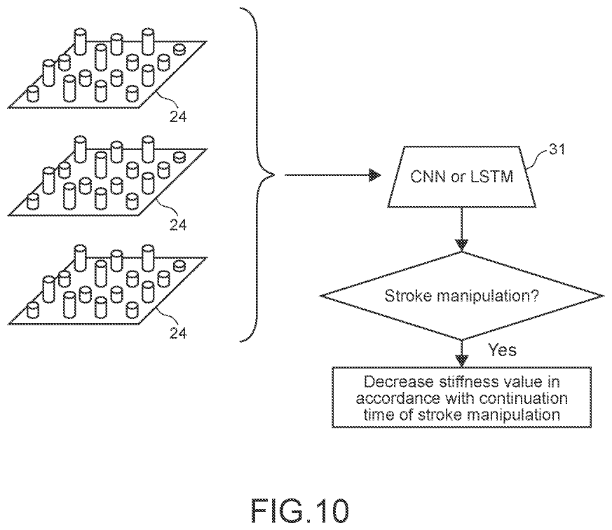

FIG. 10 is a schematic view showing an example of the determination processing by the stroke determination unit 28.

In the present embodiment, a machine learning model 31 is used for determination as to the stroke manipulation. Specifically, using the plurality of pieces of pressure distribution data 24 as the input, the machine learning model 31 determines whether or not the stroke manipulation has been made on the tactile sensor 6 and outputs a continuation time of the stroke manipulation.

For example, a convolutional neural network (CNN) is used as the machine learning model 31.

The neural network originally refers to a model that mimics human brain's neural network and is a model with a layered structure consisting of three types of layers, an input layer, an intermediate layer (hidden layer), and an output layer.

Moreover, for example, a network such as a long short-term memory (LSTM) network is used.

In addition, any type of machine learning model 31 may be employed.

The machine learning model 31 is learned on the basis of a machine learning algorithm in advance. A sufficient amount of a time series of the pressure distribution data 24 in a case where the tactile sensor 6 is stroked and a sufficient amount of a time series of the pressure distribution data 24 in a case where the tactile sensor 6 is not stroked are prepared as a learning sample.

The learning updates and generates parameters (weight and coefficient) for calculating correct solutions (training labels) as learned parameters. A program in which the generated learned parameters are incorporated is generated as the machine learning model 31.

For example, stochastic gradient descent can be used as the learning method. In addition, any machine learning algorithm may be used.

As shown in FIG. 10, the plurality of pieces of pressure distribution data 24 is input to the learned machine learning model 31.

Then, the machine learning model 31 outputs as a result of determination as to whether or not the stroke manipulation has been made on the tactile sensor 6.

Moreover, in a case where the stroke manipulation has been made, the machine learning model 31 also outputs a continuation time (e.g., several seconds) of the stroke manipulation.

In a case where the machine learning model 31 has output the result “the stroke manipulation has been made”, the set value of the stiffness is updated in Step 305.

Specifically, the stiffness control unit 20 acquires the result “the stroke manipulation has been made” and the continuation time of the stroke manipulation. The maximum value retained by the stiffness control unit 20 of the stiffness is set to be lower on the basis of the acquired information.

A decrease in the maximum value of the stiffness is set to be larger as the continuation time of the stroke manipulation increases.

For example, in a case where the maximum value of the stiffness is “50”, when the stroke manipulation is continued for one second, the maximum value of the stiffness is decreased by 10 and “40” is set.

When the stroke manipulation continues for two seconds, the maximum value of the stiffness is decreased by 20 and “30” is set.

As a matter of course, the relation between the continuation time of the stroke manipulation and the decrease in the maximum value of the stiffness is not limited thereto and may be arbitrary.

On the other hand, in a case where the machine learning model 31 has output the result “the stroke manipulation has not been made”, the maximum value of the stiffness is not changed in Step 305 and the value is retained as it is.

On the basis of not only the pressure distribution data 24, but also any information detected by the tactile sensor 6, such as the average pressure distribution data 25, the determination as to the stroke manipulation may be made. Moreover, the determination as to the stroke manipulation may be made by any method other than the method using the machine learning model 31.

Moreover, in a case where a particular portion of the tactile sensor 6 has been pressed, the stiffness may be set to decrease the stiffness of the joint 4.

For example, the tactile sensor 6 is divided into an upper half area and a lower half area. In a case where the upper half area has been grasped, the stiffness is set in accordance with the grasp force as normal. On the other hand, in a case where the lower half area has been grasped, the set stiffness is decreased.

In this case, the decrease in the stiffness may be determined in accordance with, for example, a continuation time in which the lower half area had been grasped.

Alternatively, a tactile sensor 6 for setting the stiffness and a tactile sensor 6 for decreasing the stiffness may be individually arranged.

Accordingly, a manipulation of decreasing the retained pressure is possible in a case where the stiffness control unit 20 retains the maximum pressure value.

Flexible setting is possible, for example, after setting the stiffness to be higher for the first 4/5 of the motion in the robot arm 1 with the three or more joints, the operator is able to then stroke the tactile sensor 6 and set the remaining 1/5 to be the stiffness lower.

In Steps 307 to 310, the processing similar to that in the second embodiment is executed.

### Other Embodiments

The present technology is not limited to the above-mentioned embodiments, and various other embodiments can be made.

In the example shown in FIG. 1, the operator is able to set the stiffness of the joint 4a by touching the tactile sensor 6a. Moreover, the operator is able to set the stiffness of the joint 4b by touching the tactile sensor 6b. Moreover, the operator is able to set the stiffness of the joint 4c by touching the tactile sensor 6c. In this manner, the joints 4 respectively corresponding to the tactile sensors 6 are determined in advance.

The present technology is not limited thereto, and the operator may be enabled to freely determine corresponding joints. For example, the settings may be variable, e.g., so that the operator is able to set the stiffness of the joint 4a by touching the tactile sensor 6c.

In the present technology, the tactile sensors 6 are not limited, and any pressure sensors can be used as the tactile sensors 6.

In particular, the use of the tactile sensors 6 enables a determination as to the stroke manipulation or the like, and therefore the use of the tactile sensors 6 can achieve more flexible setting of the stiffness, e.g., decreasing the set value of the stiffness on the basis of the stroke manipulation.

More accurate pressure detection can be achieved by determining positions at which the tactile sensors 6 are provided in consideration of the shape of the operator's hand 8.

The tactile sensors 6 are attached to parts on which the largest force can be easily applied when the operator grasps it, for example, a line from the index finger to the thumb finger of the hand 8 and the finger pulps. Accordingly, the degree of applying the force can be accurately reflected to the detection result.

The present technology can also be applied as a stiffness control system including only the tactile sensors 6 and the stiffness control unit 20.

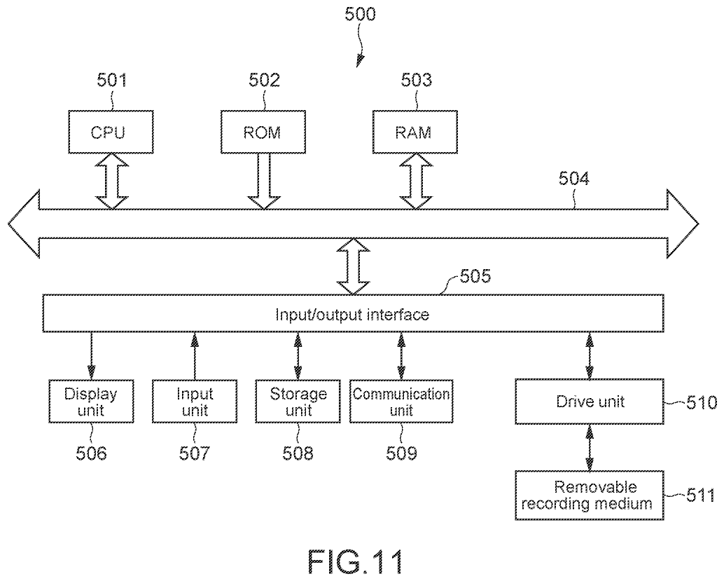

FIG. 11 is a block diagram showing hardware configuration examples of a computer 500 that can realize the information processing apparatus 2.

The computer 500 includes a CPU 501, a ROM 502, a RAM 503, an input/output interface 505, and a bus 504 that connects them to one another. A display unit 506, an input unit 507, a storage unit 508, a communication unit 509, a drive unit 510, and the like are connected to the input/output interface 505.

The display unit 506 is, for example, a display device using liquid crystals, EL, or the like. The input unit 507 is, for example, a keyboard, a pointing device, a touch panel, or another operation device. In a case where the input unit 507 includes a touch panel, the touch panel can be integral with the display unit 506.

The storage unit 508 is a nonvolatile storage device. The storage unit 508 is, for example, an HDD, a flash memory, or another solid-state memory. The drive unit 510 is, for example, a device capable of driving a removable recording medium 511 such as an optical recording medium or a magnetic record tape.

The communication unit 509 is a modem, a router, or another communication device for communicating with other devices, which is connectable to a LAN, a WAN, or the like. The communication unit 509 may perform wired communication or may perform wireless communication. The communication unit 509 is often used separately from the computer 500.

Cooperation of software stored in the storage unit 508, the ROM 502, or the like with hardware resources of the computer 500 achieves information processing of the computer 500 having the hardware configurations as described above. Specifically, loading a program that configures the software, which has been stored in the ROM 502 or the like, to the RAM 503 and executing it achieves the information processing according to the present technology.

The computer 500 installs the program via the removable recording medium 511, for example. Alternatively, the computer 500 may install the program via a global network or the like. Otherwise, any computer-readable non-transitory storage medium may be used.

Cooperation of a plurality of computers connected to be capable of communicating with each other via a network or the like may execute the information processing method according to the present technology and configure the information processing apparatus according to the present technology.

That is, the information processing method according to the present technology may be performed not only in a computer system constituted by a single computer but also in a computer system in which a plurality of computers cooperatively operate.

It should be noted that in the present disclosure, the system means a set of a plurality of components (e.g., apparatuses, modules (parts)) and it does not matter whether or not all the components are housed in the same casing. Therefore, both of a plurality of apparatuses housed in separate casings and connected to one another via a network and a single apparatus having a plurality of modules housed in a single casing are the system.

Executing the information processing method according to the present technology by the computer system includes, for example, both of a case where a single computer executes control on the stiffness and the like, and a case where different computers execute the respective processes. Moreover, executing the respective processes by a predetermined computer includes causing another computer to execute some or all of those processes and acquiring the results.

That is, the information processing method according to the present technology can also be applied to a cloud computing configuration in which a plurality of apparatuses shares and cooperatively processes a single function via a network.

The robot control system, the information processing apparatus, the respective processing flows, and the like, which have been described with reference to the respective drawings, are merely embodiments, and can be arbitrarily modified without departing from the gist of the present technology. That is, any other configurations, algorithms, and the like for carrying out the present technology may be employed.

In the present disclosure, in a case where the wording “substantially” is used, it is merely used for the sake of easy understanding of the description and the use/non-use of the wording “substantially” has no special meaning.

That is, in the present disclosure, it is assumed that the concepts that define the shape, the size, the position relationship, the state, and the like such as “center”, “middle”, “uniform”, “equal”, the “same”, “orthogonal”, “parallel”, “symmetric”, “extending”, “axial”, “columnar”, “cylindrical”, “ring-shaped”, and “annular” are concepts including “substantially center”, “substantially middle”, “substantially uniform”, “substantially equal”, “substantially the same”, “substantially orthogonal”, “substantially parallel”, “substantially symmetric”, “substantially extending”, “substantially axial”, “substantially columnar”, “substantially cylindrical”, “substantially ring-shaped”, “substantially annular”, and the like.

For example, states included in a predetermined range (e.g., +10% range) using “completely center”, “completely middle”, “completely uniform”, “completely equal”, “completely the same”, “completely orthogonal”, “completely parallel”, “completely symmetric”, “completely extending”, “completely axial”, “completely columnar”, “completely cylindrical”, “completely ring-shaped”, “completely annular”, and the like as the bases are also included.

Therefore, also a case where no wording “substantially” is added can include concepts expressed by adding so-called “substantially.” On the contrary, states expressed with “substantially” do not exclude complete states.

In the present disclosure, the comparative expressions, e.g., “larger than A” or “smaller than A” are expressions encompassing both a concept including a case where it is equal to A and a concept not including a case where it is equal to A. For example, “larger than A” is not limited to the case where not including “equal to A”, and also includes “A or more”. Moreover, “smaller than A” is not limited to “less than A”, and also includes “A or less”.

For carrying out the present technology, specific settings and the like only need to be employed as appropriate on the basis of the concepts included in “larger than A” and “smaller than A” so as to provide the above-mentioned effects.

At least two of the features according to the present technology, which have been described above, may be combined. That is, the various features described in the respective embodiments may be arbitrarily combined across the respective embodiments. Moreover, the above-mentioned various effects are merely exemplary and not limitative, and other effects may be provided.

It should be noted that the present technology can also take the following configurations.
(1) An information processing apparatus, including
   a stiffness control unit that controls, on the basis of a detection result of a pressure sensor provided at a position using a joint of a robot arm as a reference, stiffness regarding driving of the joint of the robot arm.
(2) The information processing apparatus according to (1), further including
   a storage unit that stores the stiffness set by the stiffness control unit and motion of the robot arm by driving of the joint in association with each other.
(3) The information processing apparatus according to (2), in which
   the storage unit stores the stiffness and the motion in association with each other in a case where a direct teaching mode on which an operator moves the robot arm and stores a predetermined motion is selected.
(4) The information processing apparatus according to any one of (1) to (3), in which
   the robot arm includes one or more joints and one or more links, the one or more links rotating or translating by driving of each of the one or more joints, and the stiffness control unit controls stiffness regarding rotation or translation of the one or more links.
(5) The information processing apparatus according to (4), further including
   a storage unit that stores the stiffness set by the stiffness control unit and a track of the link by driving of the joint in association with each other.
(6) The information processing apparatus according to (5), in which
   the storage unit stores the stiffness and the track in association with each other in a case where a direct teaching mode on which an operator moves the link and stores a predetermined track is selected.
(7) The information processing apparatus according to any one of (4) to (6), in which
   the stiffness control unit controls the stiffness to increase along with an increase in pressure detected by the pressure sensor.
(8) The information processing apparatus according to any one of (4) to (7), in which
   the pressure sensor is provided in a region that is a hold target of the link when an operator moves the link.
(9) The information processing apparatus according to any one of (1) to (8), further including
   a notification control unit that controls notification of the stiffness set by the stiffness control unit.
(10) The information processing apparatus according to (9), in which
   the notification control unit controls at least one of display of a value of the stiffness, display of a gauge according to a level of the stiffness, display of a color according to a level of the stiffness, or audio output of the stiffness.
(11) The information processing apparatus according to (9) or (10), in which
   the notification control unit sets, in accordance with the stiffness set by the stiffness control unit, stiffness for teaching when an operator moves the link and performs teaching.
(12) The information processing apparatus according to (11), in which
   the notification control unit sets the stiffness for the teaching to increase along with an increase in the stiffness set by the stiffness control unit.
(13) The information processing apparatus according to any one of (1) to (12), in which
   the stiffness control unit retains a maximum value of pressure detected by the pressure sensor and sets the stiffness according to the retained maximum value.
(14) The information processing apparatus according to (13), in which
   the stiffness control unit decreases the stiffness in a case where a predetermined manipulation is input to the pressure sensor.
(15) The information processing apparatus according to (14), in which
   the predetermined manipulation includes a stroke manipulation.
(16) The information processing apparatus according to any one of (1) to (15), in which
   the pressure sensor is a tactile sensor.
(17) An information processing method executed by a computer system, including
   controlling, on the basis of a detection result of a pressure sensor provided at a position using a joint of a robot arm as a reference, stiffness regarding driving of the joint of the robot arm.
(18) A robot control system, including:
   a robot arm;
   a pressure sensor provided at a position using a joint of the robot arm as a reference; and
   a stiffness control unit that controls stiffness regarding driving of the joint of the robot arm on the basis of a detection result of the pressure sensor.
(19) A program that causes a computer system to execute
   a step of controlling, on the basis of a detection result of a pressure sensor provided at a position using a joint of a robot arm as a reference, stiffness regarding driving of the joint of the robot arm.
(20) A stiffness control system, including:
   a pressure sensor provided using a position of a joint of a robot arm as a reference; and
   a stiffness control unit that controls stiffness regarding driving of the joint of the robot arm on the basis of a detection result of the pressure sensor.

### REFERENCE SIGNS LIST

100 robot control system
1 robot arm
2 information processing apparatus
4 joint
5 link
6 tactile sensor
8 hand
12 joint drive unit
14 LED
15 display
16 loudspeaker
18 storage unit
20 stiffness control unit
21 notification control unit
24 pressure distribution data
25 average pressure distribution data
28 stroke determination unit

1. An information processing apparatus, comprising
a stiffness control unit that controls, on a basis of a detection result of a pressure sensor provided at a position using a joint of a robot arm as a reference, stiffness regarding driving of the joint of the robot arm.

2. The information processing apparatus according to claim 1, further comprising
a storage unit that stores the stiffness set by the stiffness control unit and motion of the robot arm by driving of the joint in association with each other.

3. The information processing apparatus according to claim 2, wherein
the storage unit stores the stiffness and the motion in association with each other in a case where a direct teaching mode on which an operator moves the robot arm and stores a predetermined motion is selected.

4. The information processing apparatus according to claim 1, wherein
the robot arm includes one or more joints and one or more links, the one or more links rotating or translating by driving of each of the one or more joints, and
the stiffness control unit controls stiffness regarding rotation or translation of the one or more links.

5. The information processing apparatus according to claim 4, further comprising
a storage unit that stores the stiffness set by the stiffness control unit and a track of the link by driving of the joint in association with each other.

6. The information processing apparatus according to claim 5, wherein
the storage unit stores the stiffness and the track in association with each other in a case where a direct teaching mode on which an operator moves the link and stores a predetermined track is selected.

7. The information processing apparatus according to claim 4, wherein
the stiffness control unit controls the stiffness to increase along with an increase in pressure detected by the pressure sensor.

8. The information processing apparatus according to claim 4, wherein
the pressure sensor is provided in a region that is a hold target of the link when an operator moves the link.

9. The information processing apparatus according to claim 1, further comprising
a notification control unit that controls notification of the stiffness set by the stiffness control unit.

10. The information processing apparatus according to claim 9, wherein
the notification control unit controls at least one of display of a value of the stiffness, display of a gauge according to a level of the stiffness, display of a color according to a level of the stiffness, or audio output of the stiffness.

11. The information processing apparatus according to claim 9, wherein
the notification control unit sets, in accordance with the stiffness set by the stiffness control unit, stiffness for teaching when an operator moves the link and performs teaching.

12. The information processing apparatus according to claim 11, wherein
the notification control unit sets the stiffness for the teaching to increase along with an increase in the stiffness set by the stiffness control unit.

13. The information processing apparatus according to claim 1, wherein
the stiffness control unit retains a maximum value of pressure detected by the pressure sensor and sets the stiffness according to the retained maximum value.

14. The information processing apparatus according to claim 13, wherein
the stiffness control unit decreases the stiffness in a case where a predetermined manipulation is input to the pressure sensor.

15. The information processing apparatus according to claim 14, wherein
the predetermined manipulation includes a stroke manipulation.

16. The information processing apparatus according to claim 1, wherein
the pressure sensor is a tactile sensor.

17. An information processing method executed by a computer system, comprising
controlling, on a basis of a detection result of a pressure sensor provided at a position using a joint of a robot arm as a reference, stiffness regarding driving of the joint of the robot arm.

18. A robot control system, comprising:
a robot arm;
a pressure sensor provided at a position using a joint of the robot arm as a reference; and
a stiffness control unit that controls stiffness regarding driving of the joint of the robot arm on a basis of a detection result of the pressure sensor.
